(19) United States
(12) Patent Application Publication
(10) Pub. No.: US 2026/0117748 A1
(43) Pub. Date: Apr. 30, 2026

(54) PLANETARY GEARBOX COMPRISING A SUN GEAR MOUNTED IN A PLANETARY CARRIER

(71) Applicant: FLENDER GmbH, Bocholt (DE)

(72) Inventors: Ralf Kleine-Brockhoff, Bocholt (DE); VOLKER LENSING, Bocholt (DE); MICHAEL VENNEMANN, Bocholt (DE)

(73) Assignee: FLENDER GmbH, Bocholt (DE)

(21) Appl. No.: 19/469,766

(22) PCT Filed: Mar. 28, 2024
(86) PCT No.: PCT/EP2024/058579

§ 371 Date: Sep. 26, 2025

(30) Foreign Application Priority Data
Mar. 28, 2023 (EP) 23164531.8

(51) Int. Cl. F03D 15/10; F16H 1/46; F16H 57/08

(52) U.S. Cl. CPC F03D 15/101; F16H 1/46; F16H 57/082; F05B 2220/706; F05B 2260/40311; F16H 2057/085

(57) ABSTRACT

A planetary transmission for a wind turbine driven by a rotor includes a transmission housing, and a first planetary stage provided in the transmission housing about an axis of rotation. The first planetary stage includes a sun gear, a planet carrier and a ring gear. The planet carrier is designed at least indirectly to be drivingly connected to the rotor and includes a plurality of planet gears which revolve with the planet carrier and alternately mesh with the ring gear and the sun gear. A second planetary stage is provided in the transmission housing about the axis of rotation. A bearing is arranged within the sun gear and axially supports and mounts the sun gear in relation to the planet carrier of the first planetary stage such that the sun gear is rotatable about the axis of rotation.

### DESCRIPTION

The invention relates to a planetary transmission for a wind turbine driven by a rotor, having at least one planetary stage, which revolves about an axis of rotation A_{D} in a transmission housing, wherein the at least one planetary stage has a planet carrier and a ring gear, and the planet carrier is at least indirectly drivingly connected to the rotor, and wherein the planet carrier has a plurality of planet gears which revolve with the planet carrier and alternately mesh with the ring gear and a sun gear.

The powertrain of a wind turbine is designed such that the rotor drives a main shaft mounted in a main bearing unit and the main shaft is connected to a transmission, which is usually designed as a planetary transmission, and, via the transmission, drives a generator unit. The planetary transmission comprises at least one planetary stage, wherein the main shaft usually drives the planet carrier of the at least one planetary stage and is driven in the direction of the generator via the sun gear of the planetary stage. The toothing of the planetary stages is helically toothed. With regard to the bearing assembly of the powertrain, a distinction should be made between the bearing assembly of the main shaft via the main bearing unit and the bearing support of the axial force, which acts in the at least one planetary stage and arises as a result of the helical toothing of the toothing components or by the downhill output force of the inclined transmission. The respective bearing assembly may be designed differently depending on the application.

In the present case, for the main bearing unit, the application situation is considered in which the main shaft is rigidly connected to the planet carrier of the at least one planetary stage and the planet carrier does not have its own bearing assembly in relation to the transmission housing. Instead, the main shaft uses the main bearing unit to position the first planet carrier centrally and at an exact angle within the transmission housing. The axial force to be supported as a result of the helical toothing or the downhill output force is directed in the normal direction of rotation of the rotor, i.e., in the so-called nominal operation, in the direction of the generator and reverses its direction only in the rare case of reversed rotation of the rotor. When the planet carrier of a planetary stage is considered, no free forces act on the planet carrier, i.e., the sum of the forces acting on the planet carrier is zero. However, this means that the axial force to be supported as a result of the helical toothing or the downhill output force acts on the sun gear of the planetary stage and the sun gear has to be suitably supported axially. This axial force is conventionally supported via support flanges and corresponding bearings that extend radially into the transmission housing. In particular, if a second, subsequent planetary stage is provided, the sun gear of the first planetary stage is drivingly connected to the planet carrier of the second planetary stage and, during nominal operation, the axial force is supported via a support flange arranged downstream of the second planetary stage and, during reverse operation, is supported via a support flange arranged between the two planetary stages, i.e., is diverted into the transmission housing. Each support flange has to be dimensioned to absorb the axial force and thus contributes to the weight mass of the transmission housing and the axial installation space thereof. In addition, the axial force is guided via rotating components of the planetary stages, and therefore they also have to be correspondingly dimensioned, and this takes up both weight mass and installation space. Consequently, there is a constant need to reduce the installation space and the weight mass of support flanges or even to completely dispense with them.

CN 211 314 459 U discloses a multi-stage planetary transmission in which the second planet carrier is designed as a stationary housing component. The second ring gear is mounted rotationally and the second planet gears are arranged statically. The first sun is formed integrally with the third planet carrier for conjoint rotation, with this unit being mounted rotatably in relation to the first planet carrier via a bearing. U.S. Pat. No. 6,907,951 B2 discloses a single-stage planetary transmission, in which the sun gear is formed integrally with the input/output shaft, and this unit is mounted rotatably both in relation to the transmission housing and in relation to the planet carrier.

It is the object of the invention to show measures that influence the axial force in its and their course in such a way that support flanges can be designed to reduce weight and installation space.

The object is achieved by means of a planetary transmission having the features of claim 1. Preferred refinements are specified in the dependent claims and the description below and can each represent an aspect of the invention individually or in combination. If a feature is presented in combination with another feature, this serves only for simplified presentation of the invention and is in no way intended to mean that this feature cannot also be a development of the invention without the other feature.

One embodiment relates to a planetary transmission for a wind turbine driven by a rotor, having at least one first planetary stage, which revolves about an axis of rotation A_{D} in a transmission housing, and at least one second planetary stage, wherein the first planetary stage has a planet carrier and a ring gear, and the planet carrier is least indirectly drivingly connected to the rotor, and wherein the planet carrier has a plurality of planet gears which revolve with the planet carrier and alternately mesh with the ring gear and a sun gear, wherein the sun gear is mounted in relation to the planet carrier of the first planetary stage so as to be rotatable about the axis of rotation A_{D} and axially supported, and a planet carrier of the second planetary stage is mounted in relation to the planet carrier of the first planetary stage so as to be rotatable via the rolling bearing.

The planetary transmission can comprise one or more planetary stages. The respective last planetary stage can drive a generator indirectly or directly. In the case of an indirect drive, an interposed spur gear stage can be provided. The planet carrier may be of basket-like design. The axis of rotation A_{D}, about which the at least one planetary stage revolves during operation, defines the axial direction here.

The planet gears are held on the planet carrier by planet axles. The planet axles run parallel to and so as to be offset from the axis of rotation A_{D}. The planet carriers are set apart from the planet carrier or the lateral supports in a radial direction inward and a radial direction outward and are in engagement with a ring gear and a sun gear or a sun gear shaft via a respective helical toothing.

The sun gear can be mounted directly opposite or on the planet carrier. For this purpose, the planet carrier may form a suitable region which is suitable for the arrangement of a corresponding bearing assembly. Alternatively, the sun gear may also be mounted indirectly on the planet carrier, for example, by the sun gear sitting directly on an output element and the output element in tum being mounted directly on the planet carrier. An output element may be, for example, an output shaft, which conducts the torque to be transmitted to a further transmission stage. If the further transmission stage is intended to be a second planetary stage, the output shaft can be designed as a planet carrier.

Since the sun gear is axially supported in relation to or on the planet carrier, the axial force introduced into the sun gear via the helical toothing or downhill output force induced by the inclination—in the further course only the axial force is ever mentioned for simplification purposes—can be diverted into the planet carrier of the at least one planetary stage, so that the axial force is not effective in downstream parts of the planetary transmission. Within the planetary stage, the sun gear is supported axially in relation to the planet carrier. This means that the axial force which acts on the sun gear of a first planetary stage is not intended to be conducted through a possibly provided subsequent planetary stage or a subsequent spur gear transmission and correspondingly supported there. The described bearing assembly concept, namely the sun on planet carriers within a planetary stage, may be described as a rotating-in-rotating bearing assembly. This is advantageous, inter alia, for the wear behavior, since both the outer and the inner bearing element rotate and the axial force is not diverted via a fixed region, as is the case with the bearing assembly via support flanges of the transmission housing. The speed difference in downstream parts of the planetary transmission is also smaller by the factor of the first planetary stage.

By the axial force not having to be diverted via a support flange of the transmission housing, existing support flanges can either be made smaller because they no longer have to be realized with Increased axial rigidity, or they can even be completely omitted. This makes it possible to save space and weight mass in the transmission housing. The axial force introduced by the sun gear into the planet carrier during a nominal or reversing operation is supported by the main shaft in the main bearing unit.

In a preferred refinement of the planetary transmission, a bearing assembly is provided via which the sun gear is rotatably mounted in relation to the planet carrier and fixed against displacement axially. The bearing assemblies can be realized as rolling bearing assemblies, plain bearing assemblies or via thrust washers. In contrast to a bearing in the conventional arrangement in a housing-mounted support flange, the rotating-in-rotating bearing has a low peripheral load and a low speed.

In a preferred refinement, the bearing assembly is arranged within the sun gear. This makes it possible in particular to reduce the diameter of the bearing point between the sun gear and the planet carrier compared to a bearing assembly in a support flange.

In a further preferred refinement, it is provided that the meshing engagement is helically toothed, the toothing having a right-hand or left-hand direction of the helix. This directs the axial force effective during nominal operation by the helical toothing or the downhill output force toward the generator, reverses the direction of the helical toothing, and, during nominal operation, directs the direction of the axial force toward the rotor. By this means, during nominal operation, the axial force, which is effective by the helical toothing, is opposed to the axial force introduced into the main shaft by the rotor and reduces the axial force effective in total in the main shaft. The axial force generated by the helical toothing and, by reversal of the direction of the helix, directed toward the rotor thus relieves the main bearing unit of load.

In a preferred refinement of the planet carrier, the sun gear is mounted at least indirectly on an axially directed bearing flange of the planet carrier. This bearing flange and the connection to the rest of the structure of the planet carrier makes it possible for the latter to be much more torsionally rigid. In a specific refinement, it can be provided that the bearing flange is formed integrally with the planet carrier or, as an annular component connected to the planet carrier, forms a functional unit.

In the refinement according to the invention of the planetary transmission, in which at least one second planetary stage is provided with a planet carrier and the planet carrier of the second planetary stage is rotatably mounted in relation to the planet carrier of the first planetary stage via the bearing, structural and constructive advantages arise as a result of a rotating-in-rotating bearing assembly of the sun gear compared to the planet carrier in the first planetary stage. Conventionally, the axial force acting on the sun gear is directed toward the generator and is guided by the sun gear via the planet carrier of the second planetary stage and introduced into a support flange downstream of the second planetary stage via a bearing assembly. However, since a rotating-In-rotating bearing assembly of the sun gear in relation to the planet carrier is now provided in the first planetary stage, the axial force is no longer conducted via the second planetary stage, and therefore the support flange downstream of the second planetary stage can be omitted or reduced in size and therefore space and weight mass can be saved. In addition, however, the rotating-in-rotating bearing assembly also eliminates the support flange conventionally arranged between the first and the second planetary stage. This support flange is conventionally provided to support the axial force arising in the opposite direction in a reversing operation of the rotor. The axial force in the reversing operation is now also introduced via the planet carrier of the first planetary stage into the main bearing unit and supported by the latter. It is also advantageous here that the toothing elements, which have been set apart from the axial force by the modified bearing assembly, can be better aligned during operation and can also be kept narrower overall. In summary, it should be mentioned as an advantage that, by means of this preferred refinement, the planetary transmission can be designed to be significantly shorter, since installation space between the two planetary stages and downstream of the second planetary stage can be saved. Furthermore, it is possible to design the planet carrier of the second planet carrier to have a support on one side, since it no longer has to withstand the loading due to the axial force.

In one specifically designed refinement, the planet carrier of the second planetary stage is connected to the sun gear of the first planetary stage for conjoint rotation and so as to be axially supported. Starting from this, it follows as a first possibility of the constructive embodiment that the bearing of the rotating-in-rotating bearing assembly is arranged between the first planet carrier and the first sun gear, and as a second possibility of the constructive embodiment that the bearing of the rotating-in-rotating bearing assembly is arranged between the first planet carrier and the second planet carrier. In the second constructive embodiment option, it can be provided in particular that the bearing assembly is arranged in an axial region formed by an axially overlapping arrangement of the bearing flange of the first planet carrier with a hub of the second planet carrier.

In a preferred refinement, it can be provided that the sun gear of the first planetary stage is held externally circumferentially on the hub of the second planet carrier via a pair of toothings for conjoint rotation. This makes it advantageously possible to move the first planetary stage and the second planetary stage structurally closer together in the axial direction. In this case, the sun gear of the first planetary stage can be connected in the axial direction in relation to the second planet carrier.

In a further possible refinement of the planetary transmission, it can be provided that a second rolling bearing assembly is provided, via which the second planet carrier is rotatably mounted in relation to the transmission housing on the side facing away from the first planetary stage. This refinement is expedient in particular when the planetary transmission comprises a third planetary stage and the axial force, which arises in the third planetary stage during a reversing operation of the rotor, has to be supported via a support flange between the second and third planetary stage. In this case, this support flange can be used for a bearing assembly of the planet carrier of the second planetary stage, and therefore, together with the rolling bearing between the sun gear and the planet carrier of the first planetary stage, a four-point bearing assembly is created.

The object is moreover achieved by a powertrain for a wind turbine for the torque-transmitting connection of a rotor to a generator, comprising a main bearing unit having a bearing housing and a main shaft, and a transmission driven by the main shaft, wherein the transmission drives the generator at least indirectly, and the transmission is designed as a planetary transmission according to one of the embodiments described.

Similarly, the object is achieved by a wind turbine, comprising a rotor flange with a rotor and a generator, wherein a powertrain which is held on a machine support and connects the rotor flange to the generator is provided, and the powertrain is designed as described above.

Below, the invention will be explained by way of example with reference to the appended drawings on the basis of preferred exemplary embodiments, wherein the features presented below may in each case individually or in combination represent an aspect of the invention. It is shown in:

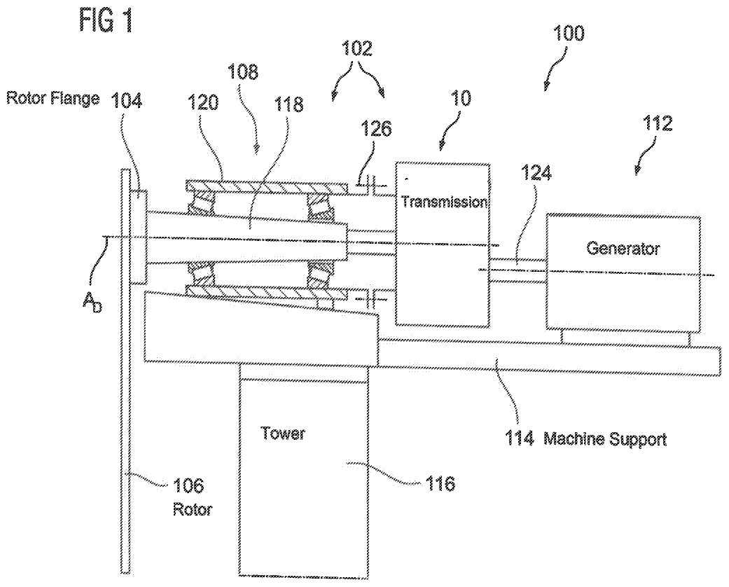

FIG. 1: a schematic illustration of a wind turbine,

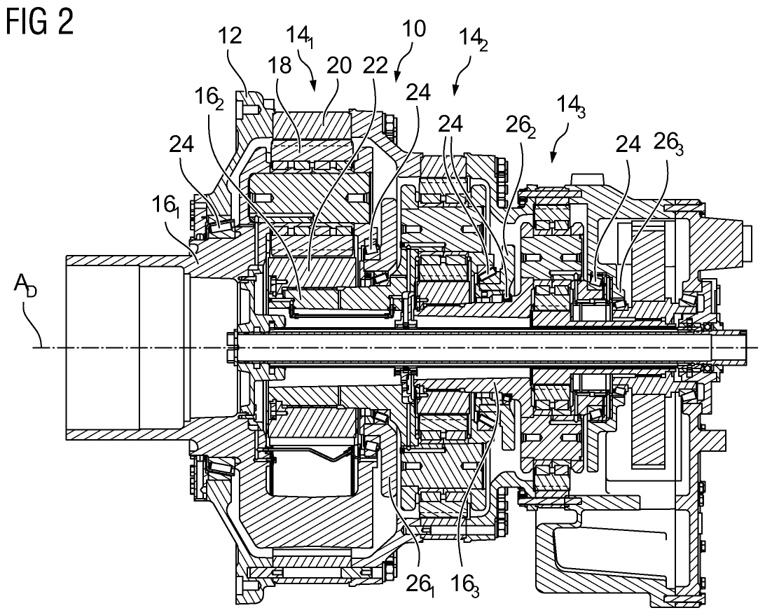

FIG. 2: a transmission designed as a planetary transmission for a wind turbine,

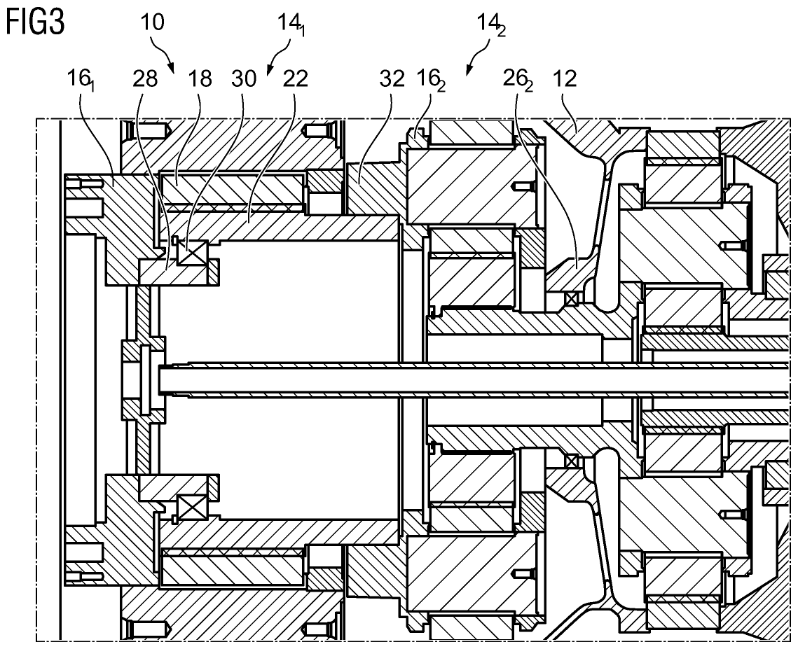

FIG. 3: cutout of a planetary transmission in a possible embodiment with a rotating-in-rotating bearing assembly;

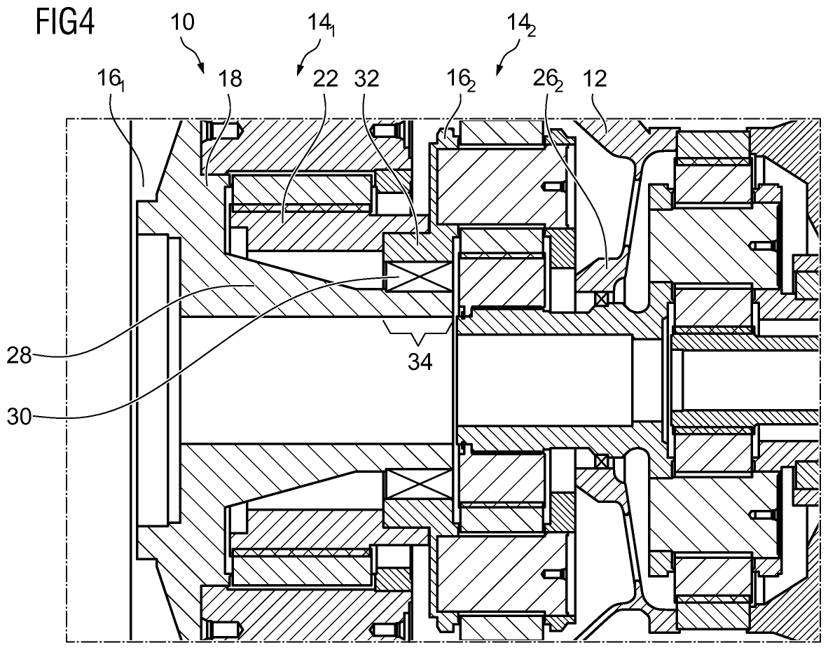

FIG. 4: a cutout of a planetary transmission in a possible embodiment with a rotating-in-rotating bearing assembly;

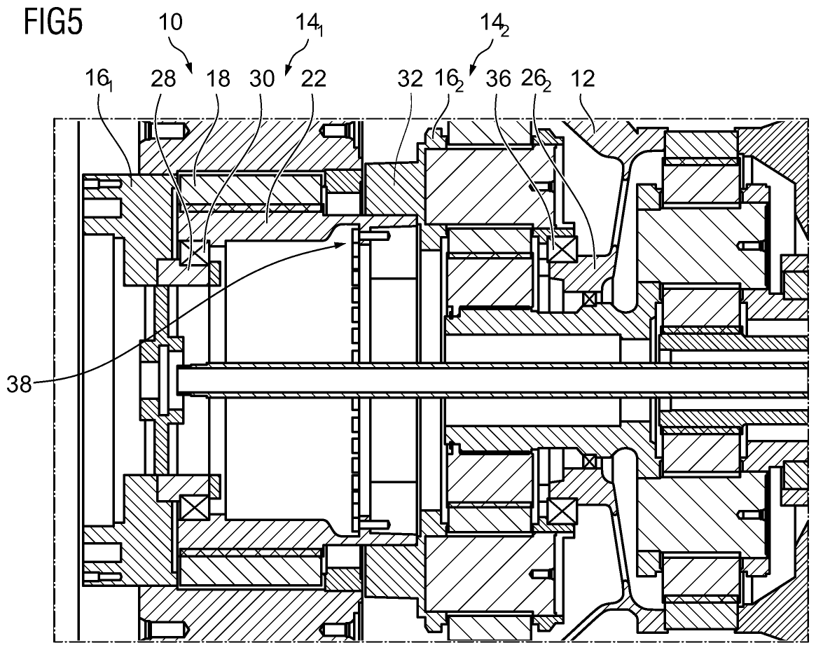

FIG. 5: a cutout of a planetary transmission in a possible embodiment with a rotating-in-rotating bearing assembly, and

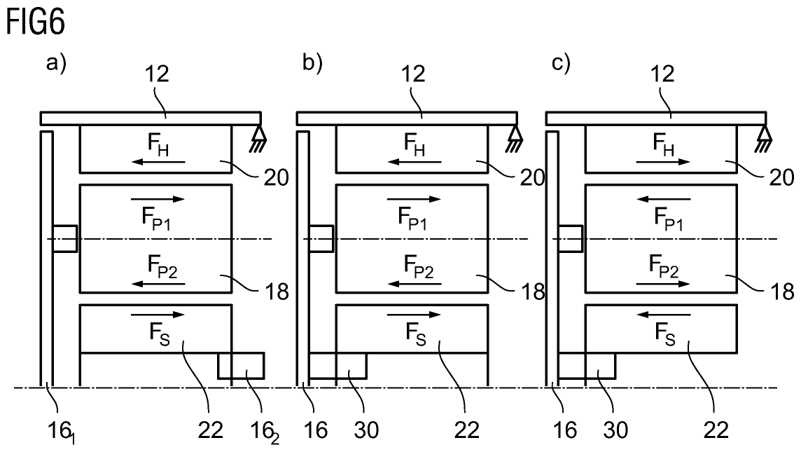

FIG. 6a)-6c): show axial forces generated by the helical toothing of the first planetary stage.

FIG. 1 shows, in a schematic illustration which is not true to scale, a wind turbine 100 in one possible embodiment. A substantial element of the wind turbine 100 is a powertrain 102, which in the present case structurally comprises a rotor flange 104 with a rotor 106, a main bearing unit 108, a transmission 10 and a generator 112. By way of a machine support 114, at least the main bearing unit 108 and the generator 112 are supported relative to the ground, which is not Illustrated, by way of a tower 116. The main bearing unit 108 comprises a main shaft 118 which is mounted by a positioned tapered rolling bearing assembly so as to be rotatable about an axis of rotation A_{D} relative to a bearing housing 120 of the main bearing unit 108. The rotor flange 104 is held at one end of the main shaft 118 and the rotor 106 is held on the former. The other end of the main shaft 118 is connected here rigidly in terms of drive to the transmission 10 in order to Introduce into the transmission 10 a drive torque applied by the rotor 106. The transmission 10 can be embodied as a planetary transmission with one or more planetary stages. The transmission 10 is connected in terms of drive to the generator 112 by a generator shaft 124. The bearing housing 120 is connected to the transmission 10 via a flange 126. A reaction moment of the transmission 10 is supported with respect to the machine support 114 via the flange 126.

FIG. 2 shows a transmission designed as a planetary transmission 10, as can be installed, for example, in a wind turbine 100 shown in FIG. 1. The planetary transmission 10 comprises three serially arranged planetary stages 14₁ to 14₃ which are arranged so as to revolve about an axis of rotation A_{D} in a transmission housing 12. Each planetary stage 14₁ to 14₃, apart from its dimensioning, is constructed accordingly and comprises a planet carrier 16, a ring gear 20, a sun gear 22 and a plurality of planet gears 18 which revolve with the planet carrier 16 and alternately mesh with the ring gear 20 and the sun gear 22 in a helically toothed manner. A feature of the design of the planetary transmission 10 is that each of the sun gears 22 is connected to the planet carrier 16 of the subsequent planetary stage 14 for conjoint rotation and fixed against displacement axially. A further feature of the design is that the planet carriers 16₂ and 16₃ of the second and third planetary stages 14₂ and 14₃ are each supported via bearings 24 on housing-side support flanges 26. Three support flanges 26₁ to 26₃ are provided, of which the first two are each arranged between the planetary stages 14₁ to 14₃ and one on the output side of the third planetary stage 14₃. During the reversing operation, the axial force of the second planetary stage 14₂ is supported via the first support flange 26₁and the bearing 24, and the axial force of the third planetary stage 14₃ is supported via the second support flange 26₂ and the radially inner bearing 24. During the nominal operation, the axial force of the second planetary stage 14₂ is supported via the second support flange 26₂ and the radially outer bearing 24, and the axial force of the third planetary stage 14₃ is supported via the third support flange 26₃ and the bearing 24.

FIG. 3 shows a cutout of a planetary transmission 10 in a possible embodiment with a rotating-in-rotating bearing assembly of the sun gear 22 relative to the planet carrier 16₁ in the first planetary stage 14₁. The sun gear 22 is rotatably and axially supported on an axially directed bearing flange 28 of the planet carrier 16₁ via a rolling bearing 30. It can be seen that the bearing flange 28 is connected as a separate annular component and in a suitable manner to the planet carrier 16₁, for example via a plurality of circumferentially distributed and axially extending screw joints. Alternatively, the bearing flange 28 may also be formed integrally with the planet carrier 16₁, which is not shown here.

The planet carrier 16₂ of the second planetary stage 14₂ is also mounted so as to be rotatable and supported via the rolling bearing 30 relative to the planet carrier 16₁ of the first planetary stage 14₁, specifically in this case indirectly via the sun gear 22 of the first planetary stage 14₁. For this purpose, the sun gear 22 of the first planetary stage 14₁ has an axial width which extends beyond the toothing region common to the planet gear 18, and therefore, because of this, the sun gear 22 may also be referred to as a sun shaft. The sun gear 22 of the first planetary stage 14₁ is held internally circumferentially via a pair of toothings on a hub 32 of the second planet carrier 16₂ for conjoint rotation. The sun gear 22 of the first planetary stage 14₁ may be fixed in a suitable manner in the axial direction in relation to the hub 32, for example via a screw joint, which is not shown here.

FIG. 4 shows a cutout of a planetary transmission 10 in a further possible embodiment with a rotating-in-rotating bearing assembly of the sun gear 22 relative to the planet carrier 16₁ in the first planetary stage 14₁, The arrangement of the rolling bearing 30 is made in such a way that it is arranged in an axial region 34 formed by an axially overlapping arrangement of the bearing flange 28 of the planet carrier 16₁ of the first planetary stage 14₁ with the hub 32 of the planet carrier 16₁ of the second planetary stage 14₂. For this purpose, the bearing flange 28 of the planet carrier 16₁ of the first planetary stage 14₁ has been extended in the axial direction. The hub 32 of the planet carrier 16₂ of the second planetary stage 14₂ protrudes in the opposite axial direction in the first planetary stage 14₁ and forms the overlapping axial region 34 with the extended bearing flange 28.

FIG. 5 shows a cutout of a planetary transmission 10 in a further possible embodiment with a rotating-in-rotating bearing assembly of the sun gear 22 relative to the planet carrier 16₁ in the first planetary stage 14₁. A second rolling bearing assembly 36 is provided, via which the second planet carrier 16₁ is rotatably mounted in relation to the transmission housing 12 on the side facing away from the first planetary stage 14₁. A shaft-hub connection is referred to by reference sign 38, wherein this comprises an expanding element sitting within the sun gear 22, for acting upon the sun gear 22 radially outward against the second planet carrier 16₂. The spreading element can be of multi-part design and can have a toroidal core and a wedge ring sitting between the toroidal core and the sun gear 22 and acted upon in the axial direction.

With reference to FIG. 6 and the illustrations a), b) and c) thereof, the first planetary stage 14₁ is used to explain how the axial force F generated via the helical toothing acts. First of all, illustration a) shows the ratios corresponding to the design of the planetary transmission 10 described in FIG. 2. The helical toothing causes the production at the planet gears 18 and the planet carrier 16₁ of the axial forces F_{P1} and F_{P2}, which act in opposite directions, so that F_{P1}−F_{P2}=0. The planet carrier 161 is therefore force-free. The axial force FH arising at the ring gear 20 is absorbed and supported by the housing 12. The axial force F_{S} arising at the sun gear 22 counteracts the axial force F_{H} with respect to the direction and is absorbed by the planet carrier 16₂ and, as described above, is supported by a support flange 26 with a bearing assembly 24. The support flange and bearing assembly are not shown here for the sake of clarity. As a result of the fact that the axial force F_{S} arising at the sun gear 22 is diverted via the second planetary stage 14₂ and the support flange 26 into the housing 12, the requirements already described above regarding installation space and component strength arise.

The ratios shown in illustrations b) and c) of FIG. 6 correspond to the embodiment of the planetary transmission 10 described in FIGS. 3 and 4, with the decisive difference that, between the illustrations b) and c) of FIG. 6, the direction of the helix of the helical toothings in the planetary stage 16 is reversed. Illustration b) is based on a right-hand or left-hand direction of the helix, which can be referred to as conventional, and illustration c) is based on a reversed left-hand or right-hand direction of the helix. As a result of the reversed direction of the helix, the individual axial forces that are effective on the respective toothing element are in each case opposed between illustrations b) and c). Furthermore, as a result of the rotating-in-rotating bearing assembly of the sun gear 22 on the planet carrier 16, the axial force F_{S} arising on the sun gear 22 is introduced into the planet carrier 16 via the rolling bearing 30. Since the axial force F_{P2} of the planet gear 18 is also introduced into the planet carrier 16, F_{S}−F_{P2}=0, so that this subsystem is force-free. Furthermore, the axial force F_{H} of the ring gear 20 is absorbed and supported by the housing 12. Consequently, because of the axial force F_{P1} of the planet gear 18, the planet carrier 16 is not force-free, and the axial force F_{P1} is supported by the main bearing unit 108, as has already been described above. The difference between the ratios of the two illustrations b) and c) is that the main bearing unit 108 is acted upon by the axial force F_{P1} in respectively opposite directions. Given the ratios of illustration c), the axial force F_{P1} counteracts the wind forces, which act on the main bearing unit 108, of the rotor 106, so that the axial force F_{P1} relieves the main bearing unit of load.

### LIST OF REFERENCE SIGNS

10 Planetary transmission
12 Transmission housing
14 Planetary stage
16 Planet carrier
18 Planet gears
20 Ring gear
22 Sun gear
24 Rolling bearing assembly
26 Support flange
28 Bearing flange
30 Rolling bearing
32 Hub
34 Axial region
36 Rolling bearing assembly
38 Shaft-hub connection
100 Wind turbine
102 Powertrain
104 Rotor flange
106 Multi-blade rotor
108 Main bearing unit
112 Generator
114 Machine support
116 Tower
118 Main shaft
120 Bearing housing
124 Generator shaft
126 Flange

1.-16. (canceled)

17. A planetary transmission for a wind turbine driven by a rotor, the planetary transmission comprising:
a transmission housing;
a first planetary stage provided in the transmission housing about an axis of rotation, said first planetary stage comprising a sun gear, a planet carrier and a ring gear, said planet carrier being designed at least indirectly to be drivingly connected to the rotor and comprising a plurality of planet gears which revolve with the planet carrier and alternately mesh with the ring gear and the sun gear;
a second planetary stage provided in the transmission housing about the axis of rotation; and
a bearing arranged within the sun gear and axially supporting and mounting the sun gear in relation to the planet carrier of the first planetary stage such that the sun gear is rotatable about the axis of rotation.

18. The planetary transmission of claim 17, wherein the planet gears alternately mesh with the ring gear and the sun gear via a helically toothing, the toothing having a right-hand or left-hand direction of a helix.

19. The planetary transmission of claim 17, wherein the planet carrier comprises an axially directed bearing flange, said sun gear being mounted at least indirectly on the bearing flange of the planet carrier.

20. The planetary transmission of claim 19, wherein the bearing flange is formed integrally with the planet carrier or is embodied as an annular component connected to the planet carrier to form with the planet carrier a functional unit.

21. The planetary transmission of claim 17, wherein the planet carrier of the second planetary stage is connected to the sun gear of the first planetary stage for conjoint rotation and in an axially supported manner.

22. The planetary transmission of claim 19, wherein the second planetary stage comprises a planet carrier which includes a hub, said bearing being designed as a rolling bearing assembly arranged in an axial region formed by an axially overlapping arrangement of the bearing flange of the planet carrier of the first planetary stage with the hub of the planet carrier of the second planetary stage.

23. The planetary transmission of claim 22, wherein the sun gear of the first planetary stage is held circumferentially on the hub of the planet carrier of the second planetary stage via a pair of toothings for conjoint rotation.

24. The planetary transmission of claim 17, wherein the second planetary stage comprises a planet carrier, said sun gear of the first planetary stage being screwed in an axial direction in relation to the planet carrier of the second planetary stage.

25. The planetary transmission of claim 17, wherein the second planetary stage comprises a planet carrier, the planetary transmission further comprising a bearing assembly designed to rotatably mount the planet carrier of the second planetary stage in relation to the transmission housing on a side facing away from the first planetary stage.

26. The planetary transmission of claim 22, wherein the second planetary stage comprises a planet carrier, said planet carrier of the second planetary stage designed to have a support on one side.

27. A powertrain for a wind turbine for a torque-transmitting connection of a rotor to a generator, the powertrain comprising:
a main bearing unit comprising a bearing housing and a main shaft; and
a transmission driven by the main shaft and driving the generator at least indirectly, said transmission being designed as the planetary transmission of claim 17.

28. A wind turbine, comprising:
a rotor flange comprising a rotor;
a generator;
a machine support; and
a powertrain held on the machine support and designed to connect the rotor flange to the generator, said powertrain comprising a main bearing unit comprising a bearing housing and a main shaft, and a transmission driven by the main shaft and driving the generator at least indirectly, said transmission being designed as the planetary transmission of claim 17.
